(19) United States
(12) Patent Application Publication
(10) Pub. No.: US 2015/0003946 A1
(43) Pub. Date: Jan. 1, 2015

(54) PLATFORM FOR ORDER PICKER

(71) Applicant: Caterpillar Inc., Peoria, IL (US)

(72) Inventors: Christopher N. Verbeck, Robinson, TX (US); Jason W. Cornwell, Washington, IL (US)

(73) Assignee: Caterpillar Inc., Peoria, IL (US)

(21) Appl. No.: 14/488,351

(22) Filed: Sep. 17, 2014

(51) Int. Cl. B66F 9/19

(52) U.S. Cl. CPC B66F 9/19
USPC 414/592

(57) ABSTRACT

A platform for an order picker assembly is disclosed. The platform includes a frame assembly. The frame assembly includes a first support member and a second support member. The first and second support members are laterally spaced apart from one another and define a first axis therebetween. The platform also includes a support assembly coupled to the frame assembly. The support assembly includes a plurality of rollers. Each of the plurality of rollers is configured to rotate about a plurality of second axes. The support assembly also includes a plurality of support arms. The platform further includes at least one bar member extending between the first support member and the second support member. The platform further includes a pin element attached to the frame assembly, wherein the pin element has a circular cross section.

### TECHNICAL FIELD

The present disclosure relates to a platform, and more particularly to a platform for an order picker assembly.

### BACKGROUND

Order pickers are generally used in industrial applications to pick up products or goods from one facility and transport the same to another location or facility. The order pickers include a platform, on which the products are placed for transportation. In some cases, an operator needs to manually unload the products from the platform of the order picker, in order to transfer the products to another location or component, such as, for example, a conveyor. Accordingly, either an additional vehicle or additional personnel may need to be employed to perform the unloading operation. This may lead to additional operational costs.

U.S. Pat. No. 7,435,047 describes a loading platform for displacing goods, comprising a support frame for goods and at least one double roller device arranged in longitudinal direction, wherein the double roller device comprises a number of first roller elements situated at regular mutual distances and having a rolling surface, and a number of second roller elements situated above the first roller elements and having a rolling surface, and wherein the rolling surface of the first roller elements lies against the rolling surface of the second roller elements, characterized in that the roller elements engage movably on the frame in vertical direction.

### SUMMARY OF THE DISCLOSURE

In one aspect of the present disclosure, a platform for an order picker assembly is disclosed. The platform includes a frame assembly. The frame assembly includes a first support member provided at a first end of the frame assembly and a second support member provided at a second end of the frame assembly. The first and second support members are laterally spaced apart from one another and define a first axis therebetween. The platform also includes a support assembly coupled to the frame assembly. The support assembly includes a plurality of rollers extending between the first support member and the second support member. Each of the plurality of rollers is configured to rotate about a plurality of second axes, such that the plurality of second axes is perpendicular to the first axis. The support assembly also includes a plurality of support arms extending between the first and second support members. The plurality of support arms is provided in an alternate arrangement with respect to the plurality of rollers. Also, at least one of the plurality of rollers and the plurality of support arms is configured to move along a third axis such that the third axis is perpendicular to the first axis and the plurality of second axes. Further, an adjustment height is defined between the plurality of rollers and the plurality of support arms. The adjustment height is changed based on the movement of the at least one of the plurality of rollers and the plurality of support arms. The platform also includes at least one bar member extending between the first and second support members. The platform further includes a pin element attached to the frame assembly, wherein the pin element has a circular cross section.

Other features and aspects of this disclosure will be apparent from the following description and the accompanying drawings.

### BRIEF DESCRIPTION OF THE DRAWINGS

FIG. 1 is a perspective view of an exemplary order picker assembly, according to one embodiment of the present disclosure;

FIG. 2 is a perspective view of an exemplary platform for the order picker assembly of FIG. 1;

FIG. 3 is a perspective view of the platform of FIG. 2 showing movement of a plurality of rollers of the platform, according to one embodiment of the present disclosure; and

FIG. 4 is a perspective view of the platform showing movement of a plurality of support arms of the platform, according to some embodiments of the present disclosure.

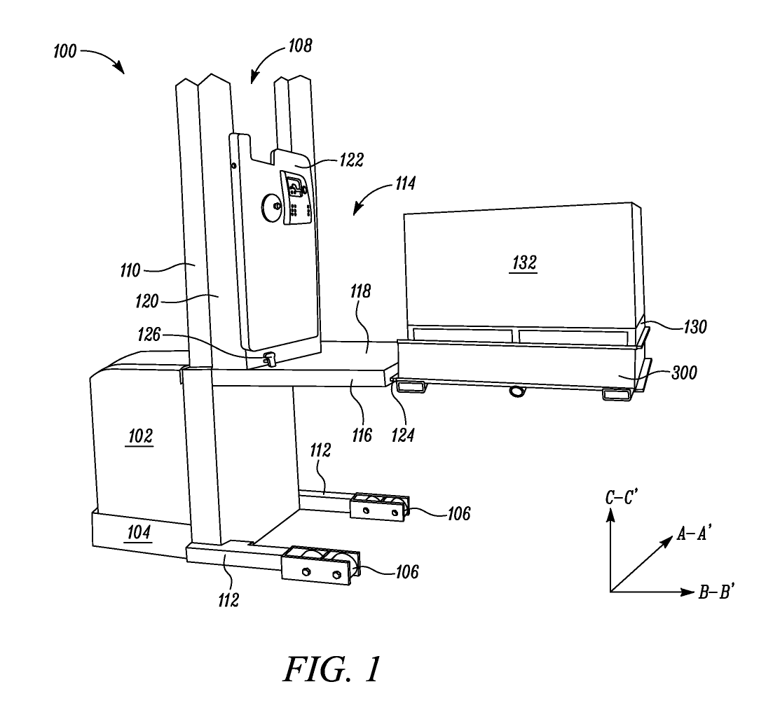

### DETAILED DESCRIPTION

Wherever possible, the same reference numbers will be used throughout the drawings to refer to the same or the like parts. FIG. 1 is a perspective view of an exemplary order picker assembly 100, according to one embodiment of the present disclosure. The order picker assembly 100 may be configured to move products or goods within a warehouse, outside of the warehouse, to or within a distribution center, or on a worksite. In one example, the order picker assembly 100 may be a lift truck. Alternatively, the order picker assembly 100 may embody any machine configured to move products from one place to another.

The order picker assembly 100 includes a power unit assembly 102. The power unit assembly 102 may provide power to the order picker assembly 100 for mobility, other operational needs, or both. The power unit assembly 102 includes a base structure 104. The power unit assembly 102 also includes a power source (not shown). In one example, the power source may be a battery unit. The power source is provided on the base structure 104 of the power unit assembly 102. The power unit assembly 102 may also include traction motors (not shown) for driving the order picker assembly 100 from one location to another. The power unit assembly 102 may also include a traction motor steering module (not shown) for controlling the operation of the traction motor, for example, speed and direction, in response to inputs from an operator of the order picker assembly 100. Further, the order picker assembly 100 includes a steerable drive tire (not shown) and a pair of drive wheels 106 in order to propel the order picker assembly 100.

The order picker assembly 100 includes a mast assembly 108. The mast assembly 108 is fixedly coupled to the power unit assembly 102. The mast assembly 108 includes a vertical mast 110. A pair of horizontal members 112 project from the vertical mast 110 of the mast assembly 108. The horizontal members 112 are provided with the drive wheels 106. Further, the mast assembly 108 includes a carriage assembly 114. The carriage assembly 114 may be vertically movable along a height of the vertical mast 110. In one example, the carriage assembly 114 may be operated hydraulically. Alternatively, the carriage assembly 114 may be operated pneumatically or mechanically, based on inputs from the operator. The carriage assembly 114 includes an operator platform 116 having a horizontal surface 118 on which the operator may stand to operate the order picker assembly 100.

The carriage assembly 114 also includes a frame 120 extending from the operator platform 116. The frame 120 is provided with an operator interface 122. The operator interface 122 may include, for example, a gauge (not shown) to display battery level of the battery unit. The operator interface 122 may also include a steering control mechanism (not shown), which may be communicably coupled to the traction motor steering module. The operator may operate the steering control mechanism to maneuver the order picker assembly 100. The operator interface 122 may also include a lever (not shown) to move the carriage assembly 114 vertically, as per operational requirements. The operator interface 122 may further include a plurality of input devices in addition to those mentioned above for controlling the order picker assembly 100 and to perform various operations thereon, without limiting the scope of the present disclosure.

The order picker assembly 100 may also include a braking arrangement to halt a movement of the order picker assembly 100. In the illustrated embodiment, the braking arrangement includes a foot activated brake pedal 126 provided on the operator platform 116 of the carriage assembly 114. Alternatively, the braking arrangement may include a hand operated lever provided on the operator interface 122.

The carriage assembly 114 also includes a load platform 124. In the present disclosure, the load platform 124 is embodied as a pair of forks (not shown). The pair of forks extends horizontally from the operator platform 116 of the carriage assembly 114. The pair of forks is configured to receive a platform 300 thereon. The load platform 124 also includes a clamping arrangement (not shown). The clamping arrangement is configured to firmly lock the platform 300 with the order picker assembly 100 so that the platform 300 does not move or disengage from the order picker assembly 100, during travel of the order picker assembly 100 on the worksite.

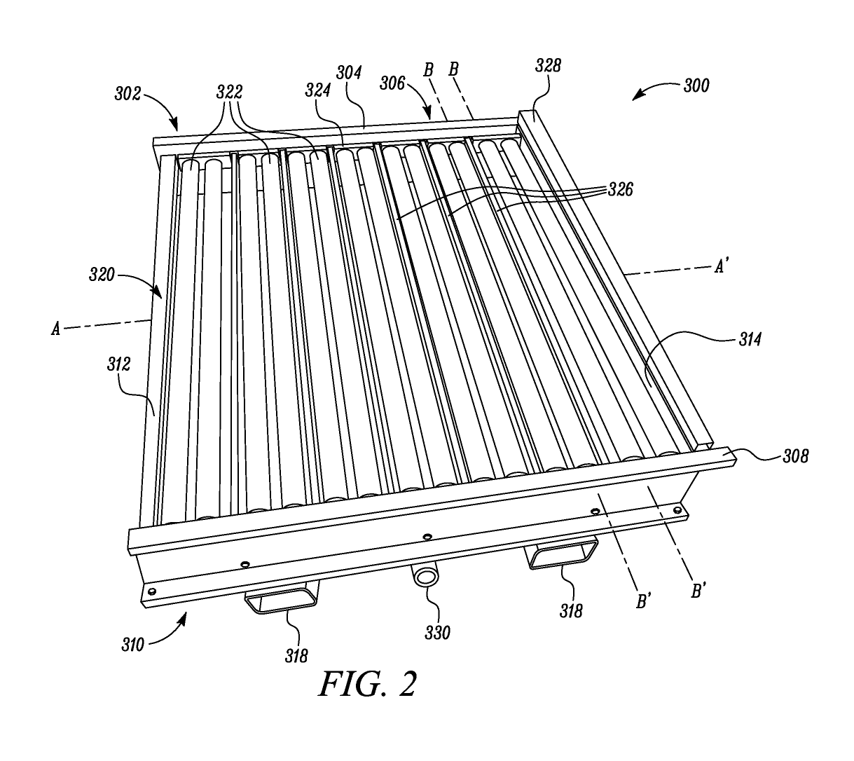

The platform 300 of the order picker assembly 100 is configured to hold a pallet 130 thereon. An order box 132 required to be transported from one place to another may be placed on the pallet 130. In the accompanying figures, a single order box 132 is placed on the pallet 130; however, a person of ordinary skill in the art will appreciate that based on the capacity of the load platform 124, a number of order boxes of various sizes may be accommodated on the pallet 130. The platform 300 of the order picker assembly 100 will now be explained in detail, with reference to FIGS. 2-4.

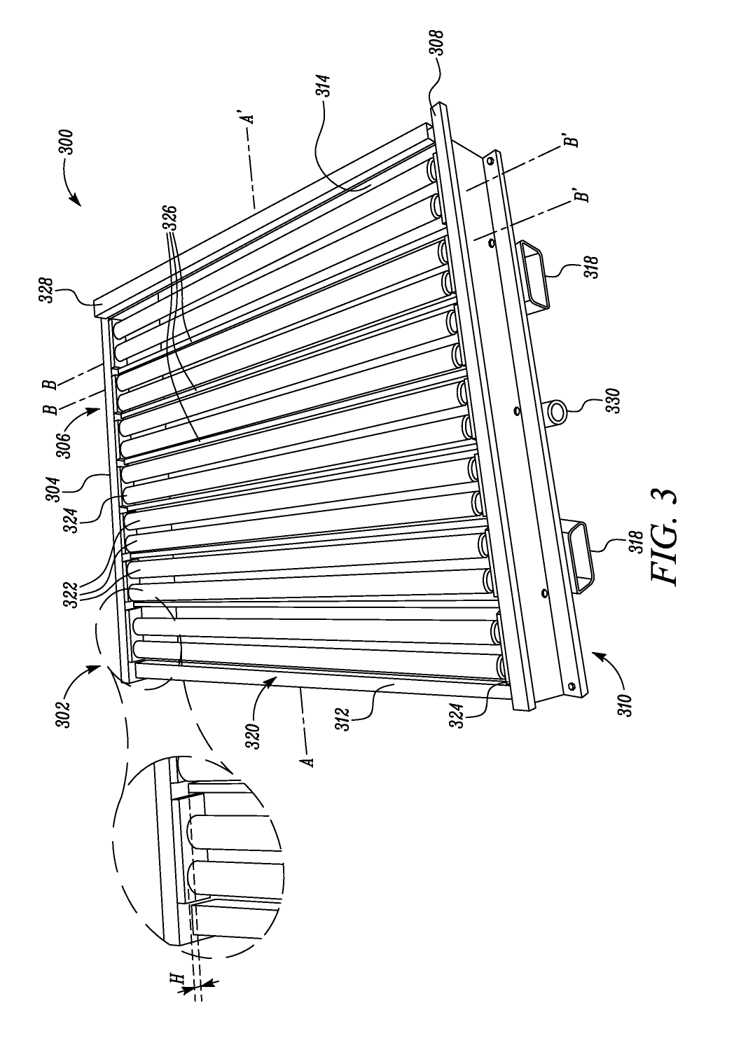

Referring to FIGS. 2 and 3, the platform 300 includes a frame assembly 302. The frame assembly 302 may be embodied as a top open-closed bottom box. The frame assembly 302 may be embodied as a square or rectangular shaped frame. The frame assembly 302 includes a first support member 304 provided at a first end 306 of the platform 300. The frame assembly 302 also includes a second support member 308 provided at a second end 310 of the platform 300. The first and second support members 304, 308 are provided in a laterally spaced apart arrangement from one another, such that the first and second support members 304, 308 define a first axis A-A′ therebetween.

The frame assembly 302 may also include a third support member 312 and a fourth support member 314. Each of the third and fourth support members 312, 314 is configured to connect the first and second support members 304, 308. The frame assembly 302 also includes a pair of support bars 318 attached to a bottom surface of the platform 300. When the platform 300 is coupled to the order picker assembly 100, the pair of support bars 318 is configured to rest on the forks of the order picker assembly 100. The components of the platform 300 may be made of any metal or polymer known in the art, without limiting the scope of the present disclosure.

The platform 300 also includes a support assembly 320. The support assembly 320 is coupled to the frame assembly 302 of the platform 300. The support assembly 320 of the platform 300 is configured to receive the pallet 130 (see FIG. 1) thereon. The support assembly 320 includes a plurality of rollers 322. The plurality of rollers 322 extend between the first and second support members 304, 308 of the platform 300. The plurality of rollers 322 define a plurality of second axes B-B′, such that the plurality of rollers 322 are configured to rotate about the plurality of second axes B-B′ respectively. Further, the plurality of second axes B-B′ of the plurality of rollers 322 is perpendicular to the first axis A-A′. One of ordinary skill in the art will appreciate that the plurality of rollers 322 is configured to provide a rolling surface on the platform 300 for assisting in loading and unloading of the pallet 130 from the platform 300, based on a sliding action of the pallet 130 on the plurality of rollers 322 during rotation thereof.

As illustrated in the accompanying figures, the support assembly 320 includes a plurality of plate members 324. The rollers 322 are configured to be connected to the first and second support members 304, 308 via the plate members 324. In the illustrated embodiment, a single plate member 324 is used to couple two adjacent rollers 322 with each of the first and second support members 304, 308.

The platform 300 also includes a plurality of support arms 326. The support arms 326 are configured to provide a resting surface for supporting the pallet 130 thereon (see FIG. 1). The support arms 326 extend between the first and second support members 304, 308, and may be positioned parallel to the plurality of rollers 322. Further, the support arms 326 are provided in an alternate arrangement with respect to the plurality of rollers 322. In the illustrated embodiment, a single support arm 326 is provided between a pair of the rollers 322. A person of ordinary skill in the art will appreciate that apart from the illustrated embodiment, any other arrangement of the support arms 326 and the rollers 322 is possible, without limiting the scope of the present disclosure. The support arms 326 have an elongate structure and may include a square or rectangle shaped cross section. The support arms 326 may be made of any known metal, alloy, or polymer.

The platform 300 of the present disclosure is provided with at least one bar member 328. In the illustrated embodiment, the bar member 328 is attached to the fourth support member 314, and extends between the first and second support members 304, 308. The bar member 328 is provided perpendicular to the first axis A-A′. Alternatively, the bar member 328 may be attached to the third support member 312. The bar member 328 is configured to provide additional support to the pallet 130. The bar member 328 is also configured to stabilize load on the platform 300.

The platform 300 also includes a pin element 330. The pin element 330 is attached to a bottom portion of the frame assembly 302. The pin element 330 is configured to engage with the clamping arrangement of the load platform 124, in order to lock the platform 300 with the order picker assembly 100. As illustrated, the pin element 330 has a circular cross-section.

The order box 132 is placed on the pallet 130, which in turn is positioned on the platform 300 in order to transport the order box 132 form one place to another. During transportation of the order box 132, the support arms 326 provide increased resistance in order to retain the pallet 130 and the order box 132 atop the platform 300. However, during the loading or unloading of the pallet 130 and the order box 132 from the platform 300, for ease of adding or removing the pallet 130 and the order box 132 from the platform 300, the rollers 322 may require to be in contact with the pallet 130, in order for the pallet 130 and the order box 132 to roll thereover.

The platform 300 of the present disclosure is designed such that the pallet 130 selectively contacts the rollers 322 or the support arms 326, based on the operation being performed by the order picker assembly 100. Accordingly, in one embodiment of the present disclosure, as shown in FIG. 3, each of the rollers 322 is configured to move along a third axis C-C′ (see FIG. 1). The third axis C-C′ is perpendicular to the first axis A-A′ and the plurality of second axes B-B′.

The rollers 322 may either move vertically upwards or downwards along the third axis C-C′. Based on the movement of the rollers 322, an adjustment height H defined between the plurality of rollers 322 and the support arms 326 may change due to the relative positioning of the rollers 322 with respect to the support arms 326. The adjustment height H may increase or decrease based on a difference in height between the rollers 322 and the support arms 326. The adjustment height H may lie between 1 to 1.5 inches. In one example, the adjustment height H may be 1.25 inches.

As discussed above, the rollers 322 are coupled to the plate members 324. In the illustrated embodiment, the plate members 324 are slidably provided on an inner side of the first and second support members 304, 308. Based on an input command from the operator via the operator interface 122, the plate members 324 may move in unison, in turn causing each of the rollers 322 to move along the third axis C-C′. It should be noted that the plate members 324 may be operated hydraulically, mechanically, or pneumatically. For example, in one embodiment wherein the order picker assembly 100 is hydraulically operated, the platform 300 may utilize the hydraulics of the order picker assembly 100 to operate the plate members 324.

During the transportation of the order box 132, each of the rollers 322 may move vertically downwards along the third axis C-C′, causing the adjustment height H to change, such that the pallet 130 is provided in contact with the support arms 326. In this situation, the adjustment height H is defined by the height between the rollers 322 and the support arms 326, such that the rollers 322 are positioned relatively lower than the support arms 326 due to the movement of the rollers 322.

During the loading or the unloading of the pallet 130, each of the rollers 322 are moved vertically upwards (see FIG. 3) along the third axis C-C′ causing the adjustment height H to change, such that the pallet 130 is provided in contact with the rollers 322. When in contact with the rollers 322, the pallet 130 may slide over the rollers 322, due to rotation thereof. The rotation of the rollers 322 may cause the pallet 130 atop the platform 300 to move over the surface of the platform 300. In this situation, the adjustment height H is defined by the height between the rollers 322 and the support arms 326, such that the rollers 322 are positioned relatively higher than the support arms 326 due to the movement of the rollers 322. Although in the current embodiment, the rollers 322 are movable and the first, second, third, and fourth support members 304, 308, 312, 314 are stationary with respect to the pallet 130, in another embodiment, the rollers 322 may be stationary while the first, second, third, and fourth support members 304, 308, 312, 314 are movable in unison to achieve the same task of unloading the order box 132.

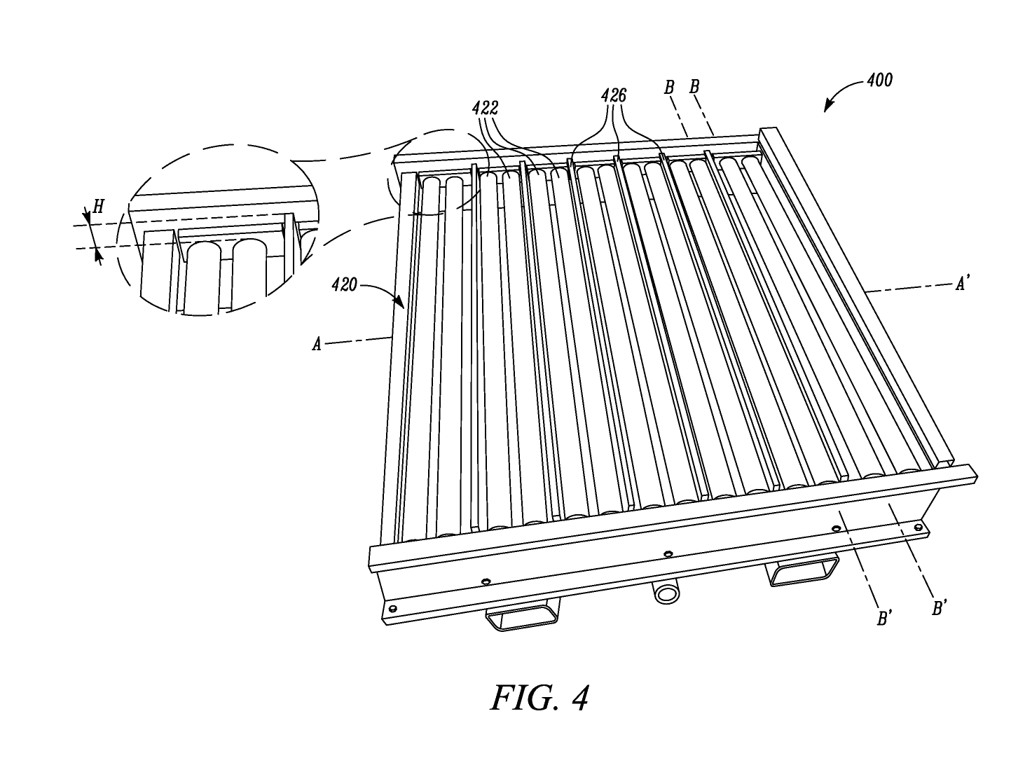

FIG. 4 illustrates a platform 400, according to some embodiments of the present disclosure. Based on the operation being performed, each of support arms 426 is movable along the third axis C-C′. Accordingly, the adjustment height H is defined based on the position of the support arms 426 with respect to rollers 422. The support arms 426 of a support assembly 420 are configured to move vertically upwards or downwards with respect to the rollers 422, thereby causing the adjustment height H to change. For example, during transportation of the order box 132, the support arms 426 are moved vertically upwards (see FIG. 4), so that the pallet 130 (see FIG. 1) is in contact therewith. In this case, the adjustment height H is defined by the height between the rollers 322 and the support arms 326, such that the support arms 426 are positioned relatively higher than the rollers 422, due to the movement of the support arms 426.

Further, during the loading or the unloading operation, each of the support arms 426 is moved vertically downwards along the third axis C-C′, such that the pallet 130 is brought in contact with the rollers 422. The adjustment height H is defined by the height between the rollers 322 and the support arms 326, such that the support arms 426 are positioned relatively lower than the rollers 422, due to the movement of the support arms 426.

In another embodiment of the present disclosure, the platform 400 may be designed such that both the rollers 422 and the support arms 426 are movable. Based on the type of operation being performed, the rollers 422 and the support arms 426 may be moved along the third axis C-C′ respectively, causing the adjustment height H to be changed.

### INDUSTRIAL APPLICABILITY

Order pickers are used for transportation of products within or outside of a manufacturing facility. Known order pickers make use of the operators of the order picker to load and unload products from the order picker. In a situation wherein the product is heavy, loading or unloading of the product may cause fatigue to the operator, causing the process to be troublesome, tedious, and laborious. Further, this may also lead to an increase in labor time. In some facilities, an additional vehicle and personnel may be required to perform these operations. This may in turn lead to an increase in operational cost.

The present disclosure relates to the ergonomically designed platform 300, 400. Based on the movement of the rollers 322, 422, the support arms 326, 426, or both the pallet 130 may be easily and automatically loaded and unloaded from the platform 300, 400 without requiring any additional vehicle or personnel.

During the loading or the unloading of the order box 132, the pallet 130 may slide on the rollers 322, 422. Therefore, the operator of the order picker assembly 100 does not need to physically pick up and transfer the order box 132 from the platform 300, 400 of the order picker assembly 100. The use of the platform 300, 400 may save on operational time for order transportation, as the operator may not have to wait for additional resources to load or unload the order boxes, thereby decreasing an overall transportation cost.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A platform for an order picker assembly, the platform comprising:
a frame assembly including a first support member provided at a first end and a second support member provided at a second end, the first and second support members provided laterally spaced apart from one another and defining a first axis therebetween;
a support assembly coupled to the frame assembly, the support assembly comprising:
a plurality of rollers extending between the first support member and the second support member, each of the plurality of rollers configured to rotate about a plurality of second axes, the plurality of second axes being perpendicular to the first axis; and
a plurality of support arms extending between the first support member and the second support member, the plurality of support arms provided in an alternate arrangement with respect to the plurality of rollers,
wherein at least one of the plurality of rollers and the plurality of support arms is configured to move along a third axis, the third axis being perpendicular to the first axis and the plurality of second axes, such that an adjustment height defined between the plurality of rollers and the plurality of support arms is changed based on the movement;
at least one bar member extending between the first support member and the second support member; and
a pin element attached to the frame assembly, the pin element having a circular cross section.
